(19) United States
(12) Patent Application Publication
(10) Pub. No.: US 2025/0217923 A1
(43) Pub. Date: Jul. 3, 2025

(54) Cloud-Based Browser Isolation with Graphics Processing Unit (GPU) Forking

(71) Applicant: Zscaler, Inc., San Jose, CA (US)

(72) Inventors: Alex Negrea, Valencia (ES); Rocco Donnarumma, Madrid (ES); Fathy Boundjadj, Bordeaux (FR)

(73) Assignee: Zscaler, Inc., San Jose, CA (US)

(21) Appl. No.: 19/061,261

(22) Filed: Feb. 24, 2025

Related U.S. Application Data
(63) Continuation-in-part of application No. 18/327,182, filed on Jun. 1, 2023.

(51) Int. Cl. G06T 1/20; H04L 67/02

(52) U.S. Cl. CPC G06T 1/20; H04L 67/02

(57) ABSTRACT

Systems and methods for browser isolation with Graphics Processing Unit (GPU) forking includes initializing a plurality of virtual GPU instances within one or more servers of a cloud-based system; receiving a rendering request from a client device; analyzing the rendering request and determining a workload distribution across a plurality of virtual Graphics Processing Unit (GPU) instances based on the analyzing; executing rendering tasks across the plurality of virtual GPU instances and generating rendering instructions; and pushing the rendering instructions to the client device.

### CROSS-REFERENCE TO RELATED APPLICATION(S)

The present disclosure is a continuation-in-part of U.S. patent application Ser. No. 18/327,182, filed Jun. 1, 2023, entitled “Systems and methods for browser isolation via a virtualized Graphics Processing Unit (GPU),” the contents of which is incorporated by reference in its entirety.

### FIELD OF THE DISCLOSURE

The present disclosure relates generally to networking and computing. More particularly, the present disclosure relates to cloud-based browser isolation with GPU forking.

### BACKGROUND OF THE DISCLOSURE

Browser (web) isolation is a technique where a user's browser or apps are physically isolated away from the user device, the local network, etc. thereby removing the risks of malicious code, malware, cyberattacks, etc. This has shown to be an effective technique for enterprises to reduce attacks. Typical pixel-based solutions provide this isolation, but simultaneously introduce a decline in user experience due to rendering taking place on cloud servers. The present disclosure provides systems and methods for providing isolation via a virtualized GPU. The present systems and methods greatly increase user experience and reduce the load on cloud infrastructure.

### BRIEF SUMMARY OF THE DISCLOSURE

In an embodiment, the present disclosure includes a method with steps, a cloud-based system configured to implement the steps, and a non-transitory computer-readable medium storing computer-executable instructions for causing performance of the steps. The steps include receiving a rendering request from a client device; analyzing the rendering request and determining a workload distribution across a plurality of virtual Graphics Processing Unit (GPU) instances based on the analyzing; executing rendering tasks across the plurality of virtual GPU instances and generating a rendered output; and pushing the rendered output including instructions to the client device.

The steps can further include, prior to the receiving, initiating a browser isolation session between the client device and a server associated with the cloud-based system. The steps can further include, prior to the receiving, initializing a plurality of virtual GPU instances within one or more servers of the cloud-based system. The steps can further include allocating computational resources including memory and processing resources to each of the plurality of virtual GPU instances. The steps can further include distributing the rendering tasks in parallel across the plurality of virtual GPU instances. The executing can include performing all read operations locally within the cloud-based system. The rendering request can be associated with any of a remote application, a browser, and an entire desktop environment. The steps can further include synchronizing states of the plurality of virtual GPU instances and a remote physical GPU of the client device. The synchronizing can be performed via any of compute fences and memory barriers. In various embodiments, no rendering is performed on the client device.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of a cloud-based system offering security as a service.

FIG. 1B is a logical diagram of the cloud-based system operating as a zero-trust platform.

FIG. 1C is a logical diagram illustrating zero trust policies with the cloud-based system and a comparison with the conventional firewall-based approach.

FIG. 2 is a network diagram of an example implementation of the cloud-based system.

FIG. 3 is a block diagram of a server, which may be used in the cloud-based system, in other systems, or standalone.

FIG. 4 is a block diagram of a user device, which may be used with the cloud-based system or the like.

FIG. 5 is a flow diagram of a typical web isolation session for illustration purposes.

FIG. 6 is a diagram of a Graphics Processing Unit (GPU) virtualization architecture.

FIG. 7 is a screenshot of a resource rendered in a browser using the present systems and methods.

FIG. 8 is a process for providing browser isolation via a virtualized Graphics Processing Unit (GPU).

FIG. 9 is a flow diagram representing GPU forking in contrast to standard GPU networking.

FIG. 10 is a flowchart of a process for providing browser isolation via virtualized Graphics Processing Units (GPUs).

### DETAILED DESCRIPTION OF THE DISCLOSURE

Again, the present disclosure presents systems and methods for cloud-based browser isolation with GPU forking. GPU forking is an advanced technology designed to optimize rendering performance in cloud computing environments. It enhances efficiency by leveraging GPU virtualization to create multiple virtual GPU instances within the cloud. These virtual GPUs handle rendering tasks in parallel, significantly reducing the time required to render each frame and ensuring a smooth and responsive user experience. Unlike traditional remote GPU rendering solutions that rely on network round-trips for read operations, GPU forking performs all read operations locally within the cloud, eliminating latency issues associated with network delays. The system employs sophisticated synchronization mechanisms, such as compute fences and memory barriers, to maintain a consistent state across all GPUs involved. This innovative approach transforms client devices into “push-only” entities, receiving rendering instructions from the cloud without the need to send data back, thereby minimizing client-side latency and load. By dynamically balancing workloads and continuously monitoring performance, GPU forking ensures high scalability and optimal performance, making it a powerful solution for modern, graphically intensive applications.

### Example Cloud-Based System Architecture

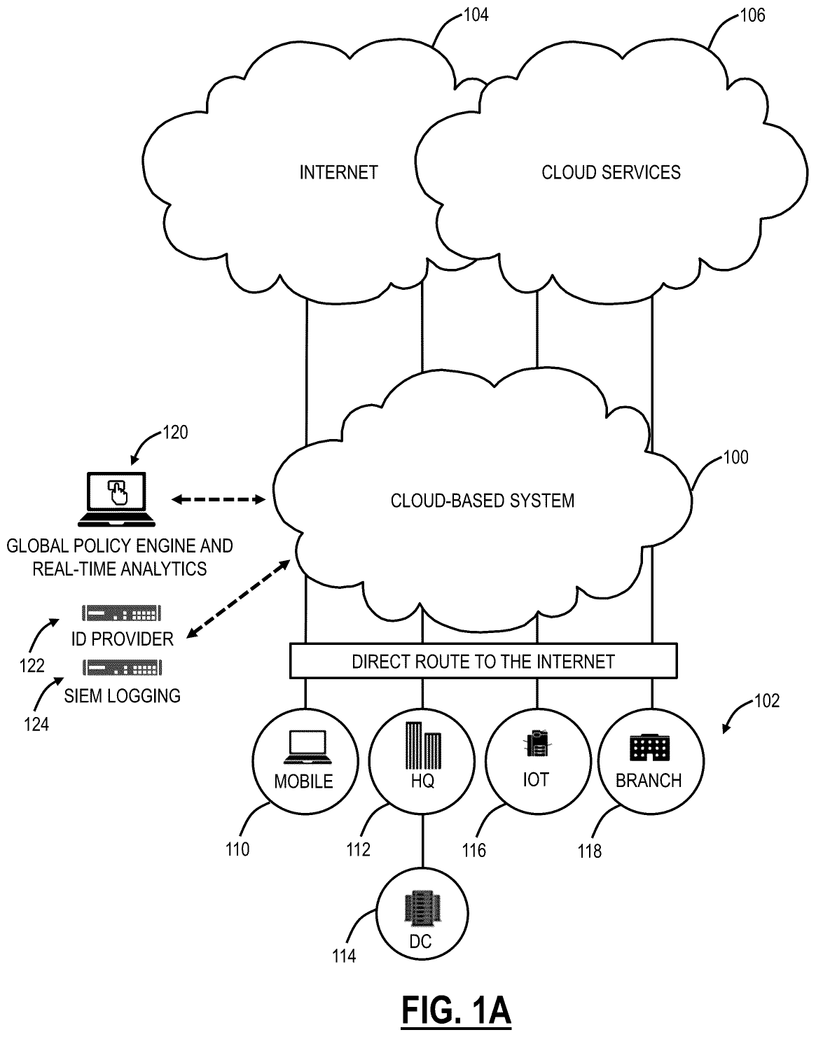

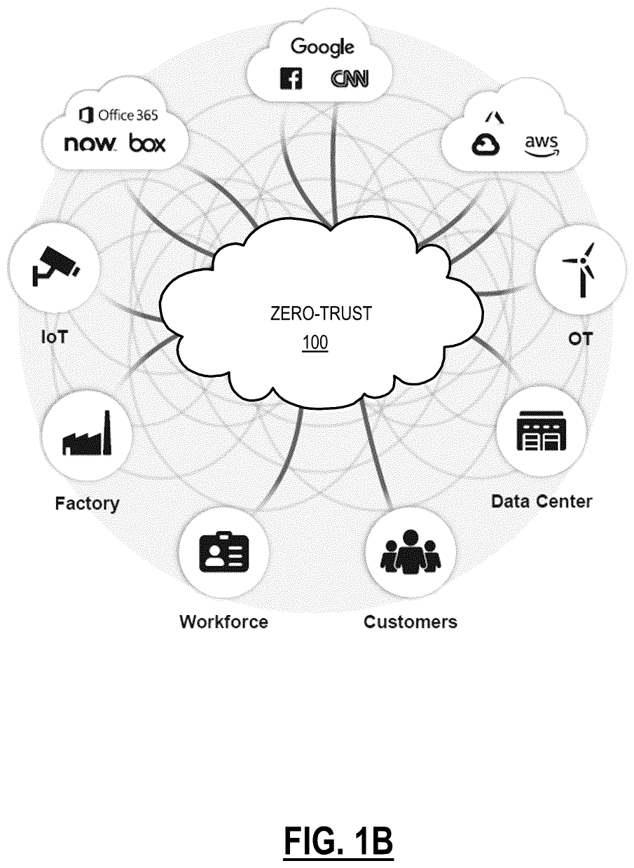

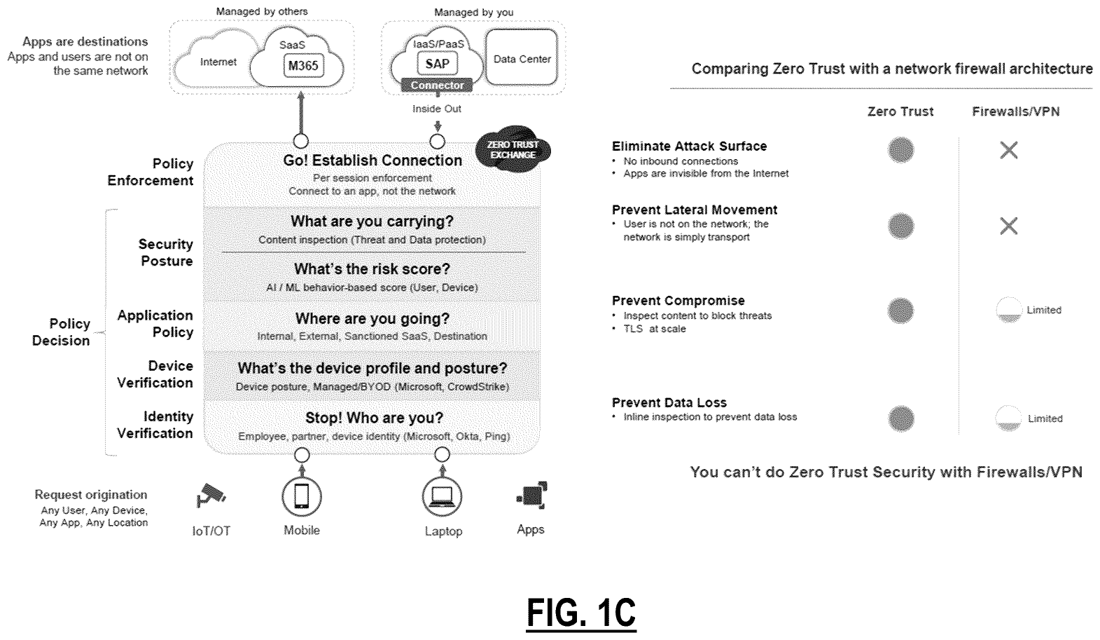

FIG. 1A is a network diagram of a cloud-based system 100 offering security as a service. Specifically, the cloud-based system 100 can offer a Secure Internet and Web Gateway as a service to various users 102, as well as other cloud services. In this manner, the cloud-based system 100 is located between the users 102 and the Internet as well as any cloud services 106 (or applications) accessed by the users 102. As such, the cloud-based system 100 provides inline monitoring inspecting traffic between the users 102, the Internet 104, and the cloud services 106, including Secure Sockets Layer (SSL) traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via a Cloud Access Security Broker (CASB), file type control, etc.

The cloud-based firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc. protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being in a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

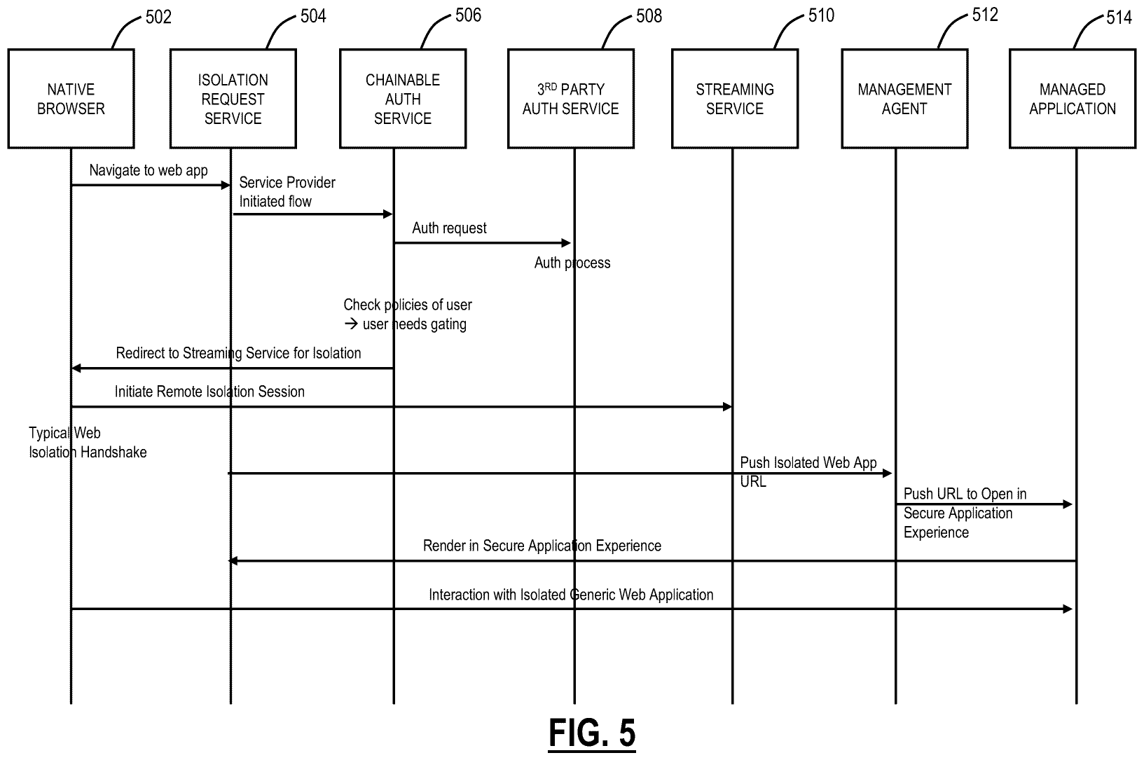

For illustration purposes, the users 102 of the cloud-based system 100 can include a mobile device 110, a headquarters (HQ) 112 which can include or connect to a data center (DC) 114, Internet of Things (IOT) devices 116, a branch office/remote location 118, etc., and each includes one or more user devices (an example user device 300 is illustrated in FIG. 5). The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters 112 can include an enterprise's network with resources in the data center 114. The mobile device 110 can be a so-called road warrior, i.e., users that are off-site, on-the-road, etc. Those skilled in the art will recognize a user 102 has to use a corresponding user device 300 for accessing the cloud-based system 100 and the like, and the description herein may use the user 102 and/or the user device 300 interchangeably.

Further, the cloud-based system 100 can be multi-tenant, with each tenant having its own users 102 and configuration, policy, rules, etc. One advantage of the multi-tenancy and a large volume of users is the zero-day/zero-hour protection in that a new vulnerability can be detected and then instantly remediated across the entire cloud-based system 100. The same applies to policy, rule, configuration, etc. changes—they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 116) and the Internet 104 and the cloud services 106. Previously, the IT deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as Generic Routing Encapsulation (GRE), Layer Two Tunneling Protocol (L2TP), Internet Protocol (IP) Security (IPsec), customized tunneling protocols, etc. The devices 110, 116, when not at one of the locations 112, 114, 118 can use a local application that forwards traffic, a proxy such as via a Proxy Auto-Config (PAC) file, and the like. An application of the local application is the application described in detail herein as a connector application. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables IT administrators to have a unified view of user activity, threat intelligence, application usage, etc. For example, IT administrators can drill-down to a per-user level to understand events and correlate threats, to identify compromised devices, to have application visibility, and the like. The cloud-based system 100 can further include connectivity to an Identity Provider (IDP) 122 for authentication of the users 102 and to a Security Information and Event Management (SIEM) system 124 for event logging. The system 124 can provide alert and activity logs on a per-user 102 basis.

### Zero Trust

FIG. 1B is a logical diagram of the cloud-based system 100 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud-based system 100. Zero trust is a cybersecurity strategy wherein security policy is applied based on context established through least-privileged access controls and strict user authentication—not assumed trust. A well-tuned zero trust architecture leads to simpler network infrastructure, a better user experience, and improved cyberthreat defense.

Establishing a zero trust architecture requires visibility and control over the environment's users and traffic, including that which is encrypted; monitoring and verification of traffic between parts of the environment; and strong multifactor authentication (MFA) methods beyond passwords, such as biometrics or one-time codes. This is performed via the cloud-based system 100. Critically, in a zero trust architecture, a resource's network location is not the biggest factor in its security posture anymore. Instead of rigid network segmentation, your data, workflows, services, and such are protected by software-defined microsegmentation, enabling you to keep them secure anywhere, whether in your data center or in distributed hybrid and multicloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

FIG. 1C is a logical diagram illustrating zero trust policies with the cloud-based system 100 and a comparison with the conventional firewall-based approach. Zero trust with the cloud-based system 100 allows per session policy decisions and enforcement regardless of the user 102 location. Unlike the conventional firewall-based approach, this eliminates attack surfaces, there are no inbound connections; prevents lateral movement, the user is not on the network; prevents compromise, allowing encrypted inspection; and prevents data loss with inline inspection.

### Example Implementation of the Cloud-Based System

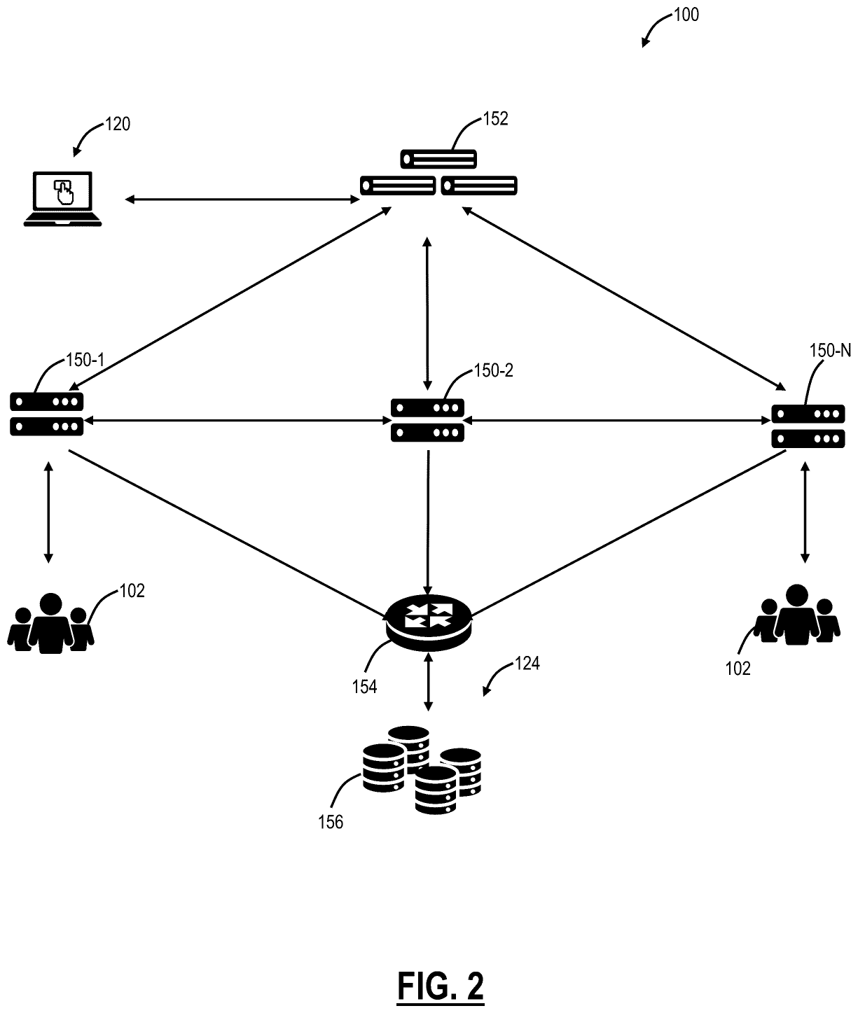

FIG. 2 is a network diagram of an example implementation of the cloud-based system 100. In an embodiment, the cloud-based system 100 includes a plurality of enforcement nodes (EN) 150, labeled as enforcement nodes 150-1, 150-2, 150-N, interconnected to one another and interconnected to a central authority (CA) 152. The nodes 150 and the central authority 152, while described as nodes, can include one or more servers, including physical servers, virtual machines (VM) executed on physical hardware, etc. An example of a server is illustrated in FIG. 4. The cloud-based system 100 further includes a log router 154 that connects to a storage cluster 156 for supporting log maintenance from the enforcement nodes 150. The central authority 152 provide centralized policy, real-time threat updates, etc. and coordinates the distribution of this data between the enforcement nodes 150. The enforcement nodes 150 provide an onramp to the users 102 and are configured to execute policy, based on the central authority 152, for each user 102. The enforcement nodes 150 can be geographically distributed, and the policy for each user 102 follows that user 102 as he or she connects to the nearest (or other criteria) enforcement node 150.

Of note, the cloud-based system 100 is an external system meaning it is separate from tenant's private networks (enterprise networks) as well as from networks associated with the devices 110, 116, and locations 112, 118. Also, of note, the present disclosure describes a private enforcement node 150P that is both part of the cloud-based system 100 and part of a private network. Further, of note, the enforcement node described herein may simply be referred to as a node or cloud node. Also, the terminology enforcement node 150 is used in the context of the cloud-based system 100 providing cloud-based security. In the context of secure, private application access, the enforcement node 150 can also be referred to as a service edge or service edge node. Also, a service edge node 150 can be a public service edge node (part of the cloud-based system 100) separate from an enterprise network or a private service edge node (still part of the cloud-based system 100) but hosted either within an enterprise network, in a data center 114, in a branch office 118, etc. Further, the term nodes as used herein with respect to the cloud-based system 100 (including enforcement nodes, service edge nodes, etc.) can be one or more servers, including physical servers, virtual machines (VM) executed on physical hardware, etc., as described above. The service edge node 150 can also be a Secure Access Service Edge (SASE).

The enforcement nodes 150 are full-featured secure internet gateways that provide integrated internet security. They inspect all web traffic bi-directionally for malware and enforce security, compliance, and firewall policies, as described herein, as well as various additional functionality. In an embodiment, each enforcement node 150 has two main modules for inspecting traffic and applying policies: a web module and a firewall module. The enforcement nodes 150 are deployed around the world and can handle hundreds of thousands of concurrent users with millions of concurrent sessions. Because of this, regardless of where the users 102 are, they can access the Internet 104 from any device, and the enforcement nodes 150 protect the traffic and apply corporate policies. The enforcement nodes 150 can implement various inspection engines therein, and optionally, send sandboxing to another system. The enforcement nodes 150 include significant fault tolerance capabilities, such as deployment in active-active mode to ensure availability and redundancy as well as continuous monitoring.

In an embodiment, customer traffic is not passed to any other component within the cloud-based system 100, and the enforcement nodes 150 can be configured never to store any data to disk. Packet data is held in memory for inspection and then, based on policy, is either forwarded or dropped. Log data generated for every transaction is compressed, tokenized, and exported over secure Transport Layer Security (TLS) connections to the log routers 154 that direct the logs to the storage cluster 156, hosted in the appropriate geographical region, for each organization. In an embodiment, all data destined for or received from the Internet is processed through one of the enforcement nodes 150. In another embodiment, specific data specified by each tenant, e.g., only email, only executable files, etc., is processed through one of the enforcement nodes 150.

Each of the enforcement nodes 150 may generate a decision vector D=[d1, d2, . . . , dn] for a content item of one or more parts C=[c1, c2, . . . , cm]. Each decision vector may identify a threat classification, e.g., clean, spyware, malware, undesirable content, innocuous, spam email, unknown, etc. For example, the output of each element of the decision vector D may be based on the output of one or more data inspection engines. In an embodiment, the threat classification may be reduced to a subset of categories, e.g., violating, non-violating, neutral, unknown. Based on the subset classification, the enforcement node 150 may allow the distribution of the content item, preclude distribution of the content item, allow distribution of the content item after a cleaning process, or perform threat detection on the content item. In an embodiment, the actions taken by one of the enforcement nodes 150 may be determinative on the threat classification of the content item and on a security policy of the tenant to which the content item is being sent from or from which the content item is being requested by. A content item is violating if, for any part C=[c1, c2, . . . , cm] of the content item, at any of the enforcement nodes 150, any one of the data inspection engines generates an output that results in a classification of “violating.”

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The enforcement nodes 150 establish persistent connections to the central authority 152 to download all policy configurations. When a new user connects to an enforcement node 150, a policy request is sent to the central authority 152 through this connection. The central authority 152 then calculates the policies that apply to that user 102 and sends the policy to the enforcement node 150 as a highly compressed bitmap.

The policy can be tenant-specific and can include access privileges for users, websites and/or content that is disallowed, restricted domains, DLP dictionaries, etc. Once downloaded, a tenant's policy is cached until a policy change is made in the management system 120. The policy can be tenant-specific and can include access privileges for users, websites and/or content that is disallowed, restricted domains, DLP dictionaries, etc. When this happens, all of the cached policies are purged, and the enforcement nodes 150 request the new policy when the user 102 next makes a request. In an embodiment, the enforcement node 150 exchange “heartbeats” periodically, so all enforcement nodes 150 are informed when there is a policy change. Any enforcement node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud service 106 is any service made available to users on-demand via the Internet, as opposed to being provided from a company's on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), and Zscaler Digital Experience (ZDX), all from Zscaler, Inc. (the assignee and applicant of the present application). Also, there can be multiple different cloud-based systems 100, including ones with different architectures and multiple cloud services. The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services 106 are also contemplated. Also, other types of cloud architectures are also contemplated, with the cloud-based system 100 presented for illustration purposes.

### Example Server Architecture

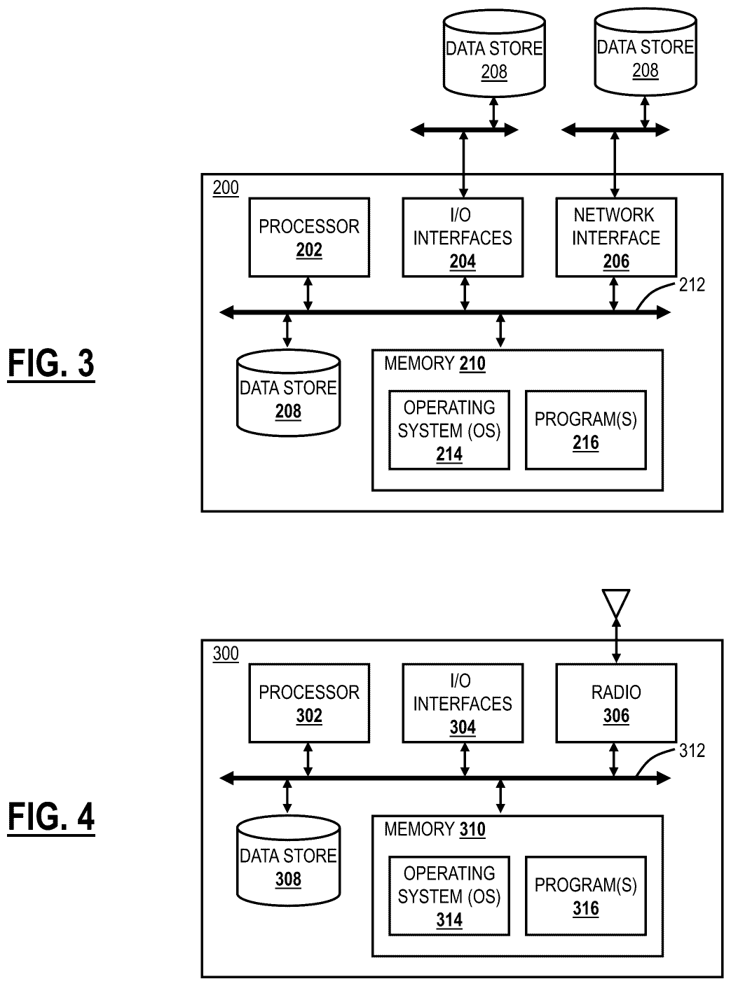

FIG. 3 is a block diagram of a server 200, which may be used in the cloud-based system 100, in other systems, or standalone. For example, the enforcement nodes 150 and the central authority 152 may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Example User Device Architecture

FIG. 4 is a block diagram of a user device 300, which may be used with the cloud-based system 100 or the like. Specifically, the user device 300 can form a device used by one of the users 102, and this may include common devices such as laptops, smartphones, tablets, netbooks, personal digital assistants, MP3 players, cell phones, e-book readers, IOT devices, servers, desktops, printers, televisions, streaming media devices, and the like. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 4 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100.

### Browser Isolation

Browser (web) isolation is a technique where a user's browser or apps are physically isolated away from the user device, the local network, etc. thereby removing the risks of malicious code, malware, cyberattacks, etc. This has been shown to be an effective technique for enterprises to reduce attacks. Traditionally browser isolation was focused on removing the risks of malicious code, malware, cyberattacks, etc. U.S. That is, because no data is delivered to the local system (e.g., to be processed by web content through the local web browser), none of the confidential or otherwise sensitive data can be retained on the local system.

The secure access can interoperate with browser isolation through the cloud-based system 100, to prevent data exfiltration, which is extremely critical as this is customer-facing data which adds to the sensitivity and liability, and also accessible to external users (customers). This functionality forces customers to interact with the B2B applications via an isolated, contained environment.

### WebSocket

WebSocket is a protocol, providing full-duplex communication channels over a single Transmission Control Protocol (TCP) connection. The WebSocket protocol was standardized by the IETF as RFC 6455 in 2011, and the WebSocket API in Web IDL is being standardized by the W3C. The present disclosure utilizes the WebSocket protocol for interaction between a web browser (or other client application), such as a native browser, and a web server. This is made possible by providing a standardized way for the server to send content to the client without being first requested by the client and allowing messages to be passed back and forth while keeping the connection open. Most browsers support the WebSocket protocol, including Google Chrome, Microsoft Edge, Internet Explorer, Firefox, Safari, and Opera. The user device can execute a web browser that loads the image content utilizing a JavaScript application and that interacts with the image content by sending keyboard and mouse inputs via a WebSocket channel. So, the native browser only has graphics (pixels) but can interact with the graphics using WebSocket.

### Example Web Isolation Session

FIG. 5 is a flow diagram of a typical web isolation session for illustration purposes. FIG. 5 describes the entities and interaction between them that are used in the process of establishing a web isolation session from a native browser. The web isolation session is an application session where one can render the content of any managed application and stream back only pixels to the native browser. Alternatively, methods can include sending GPU commands instead of pixels to the native browser. Such methods are further described herein.

In the example of FIG. 5, it is assumed the managed application is a web browser. The flow starts from the native browser 502 when an isolation request is being sent to the isolation request service 504. The isolation request can be sent in multiple ways: either directly if the user wants to access the isolation request service 504 directly or indirectly through a redirect coming from a third party service that was configured for isolation. The third-party web service can be, for example, a secure web gateway service that listens for web requests and redirects to the isolation request service 504 for the URLs that are uncategorized or potentially malicious. Another possibility is that an authentication service (such as the chainable authentication service 506) is configured based on certain policies to redirect to the isolation request service 504. The isolation request service 504 will fetch the configuration for this isolation request from a configuration storage based on certain attributes from the URL of the isolation request.

After fetching the configuration, it will seek the authentication provider needed to validate the user's credentials to access the isolation request service 504. Usually, this authentication provider is the chainable authentication service 506, which based on the configuration for this isolation request, will redirect to the proper third party authentication service 508 and complete the authentication process for the user by using one or more consequent web requests based on the authentication protocol chosen. After the user's credentials have been validated a new secure and disposable application environment (sandbox) will be allocated to the end-user by the isolation request service 504.

In the same time, for pixel based solutions, a client-side renderer (a JS-based application) will be served to the native browser 502 which will be in a wait state, waiting for the secure and disposable application environment to be initialized and fully provisioned. The isolation request service 504 will push the configuration for this isolation session to the management agent 512, which pushes the URL to the secure and disposable application environment.

Simultaneously (or right after) the isolation request service 504 will start a rendering session using an underlying HTML5 compatible protocol by connecting to a display protocol translation server which in turn will initiate a platform-native display session to the network display server residing in the secure and disposable application environment. The display protocol translation server serves as a translator service between native display protocol (such as Remote Desktop Protocol (RDP), for example) and an HTML5 compatible protocol. The network display server acts as a local bridge between the native virtual display and the network by translating raw data from the display driver to a network streamable protocol stream.

Using the Configuration received from the isolation request service 504, the management agent 512 will now push/present this information to the managed application 514 residing in the secure and disposable application environment and will instruct the managed application 514 to start within a virtual display. Simultaneously with this start of the managed application 514, a data stream will now be exposed to the network from the virtual display (on which the managed application is connected to) through the network display server and will be in turn transformed by the display protocol translation server into an HTML5 compatible protocol. The stream reaches back to the isolation request service 504 which instructs the native browser 502 via the JS application to render the HTML5 compatible protocol into native HTML5 compatible components such as a canvas, using images of various types such as JPG, PNG, or WEBP depending on various factors such as network, frame rate, type of content in the screen etc. The communication for the rendering and streaming between the native browser 502 and the isolation request service 504 is now being done over an authenticated HTML5 WebSocket.

The end user via the native browser 502 has now established a web isolation service which streams back pixels from the managed application. All the clipboard, keys and mouse operation are now being transported via the WebSocket stream through an HTML5 compatible protocol and in turn into a native display protocol stream to the remote display session. The reverse of the translation happens when the communication is being done from the native browser to the managed application.

As will be described further herein, present systems and methods provide the ability to simulate a GPU device in the cloud-based system 100. The present solution is adapted to run on the same servers and infrastructure currently in use, i.e., in the cloud-based system 100 as described above and uses less resources than currently deployed pixel-based solutions.

### Brower Isolation With Virtualized GPU

A new remote display protocol is introduced to provide minimal latency and use less computing resources than a native browser. The disclosed protocol performs better than pixel based solutions and provides a better user experience for customers. For example, when using a cellular network, the present protocol displays the initial content faster than a native browser.

The present disclosure provides systems and methods for streaming desktop applications remotely in a seamless and efficient manner to clients utilizing web browsers. The present systems do not require any changes to be made to client applications, and can be used to stream remote applications, browsers (i.e., Firefox, Chromium, etc.), and entire desktop environments (i.e., Linux, Windows, etc.). The various embodiments are adapted to simulate a graphics stack, thus eliminating the need for a window server. The present solution (zGPU) is adapted to run on the same servers and infrastructure currently in use, i.e., in the cloud-based system 100, and uses less resources than currently deployed pixel-based solutions. Further, zGPU does not require a GPU on the server.

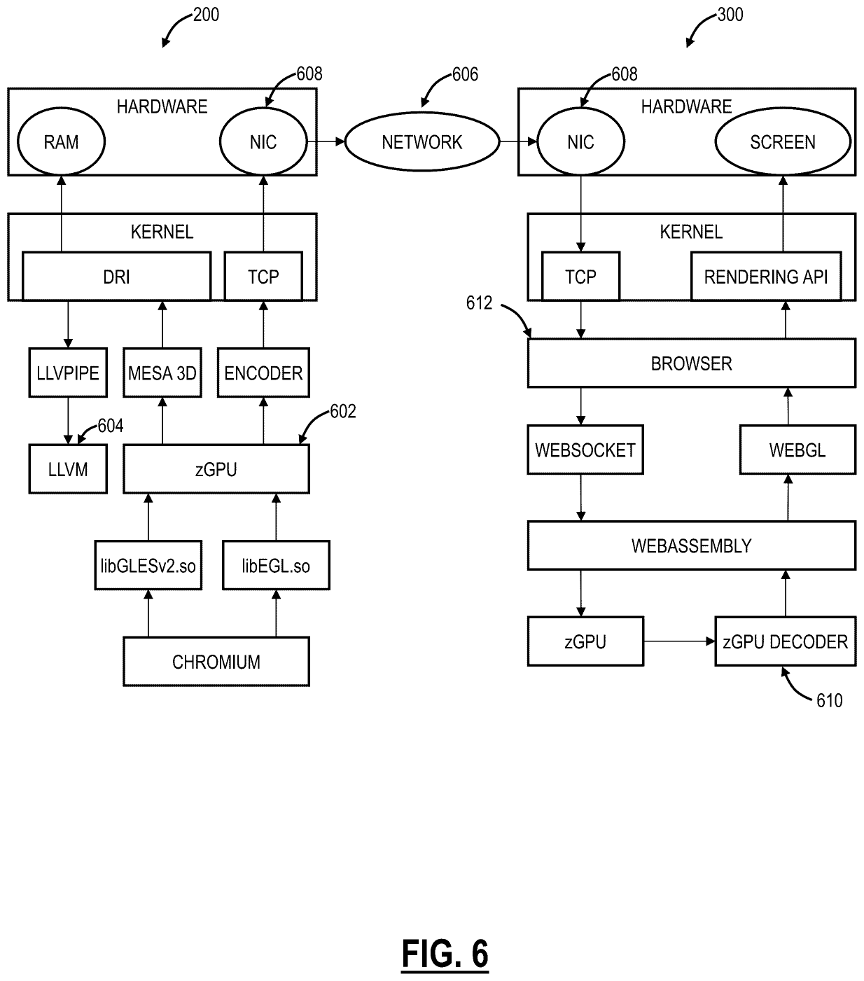

FIG. 6 is a diagram of a GPU virtualization architecture. zGPU 602 simulates a GPU device, captures rendering instructions, and replays them in a browser window inside a sandbox. In various embodiments, a GPU is virtualized in the cloud-based system 100 to execute code thereon in a safe and isolated environment. In an embodiment, the virtualized GPU (zGPU) 602 is adapted to provide a display API and a GPU API. zGPU 602 is also adapted to run commands on both the server 200, and the client (device) 300 to allow the server 200 to perform fast queries locally, the server being associated with the cloud-based system 100. In various embodiments, zGPU is based on the OpenGL graphics API. For example, zGPU provides an EGL 1.5 and OpenGL ES 2.0 interface, and runs commands such as glGetUniformLocation and glReadPixels. The server 200 utilizes a software rasterizer 604 (LLVM) in order to execute commands without a GPU and perform shader compilation. By utilizing the present systems, no rendering is performed on the server. The rendering is performed on the client 300, meaning that the server uses far less CPU than the pixel-based solutions described above.

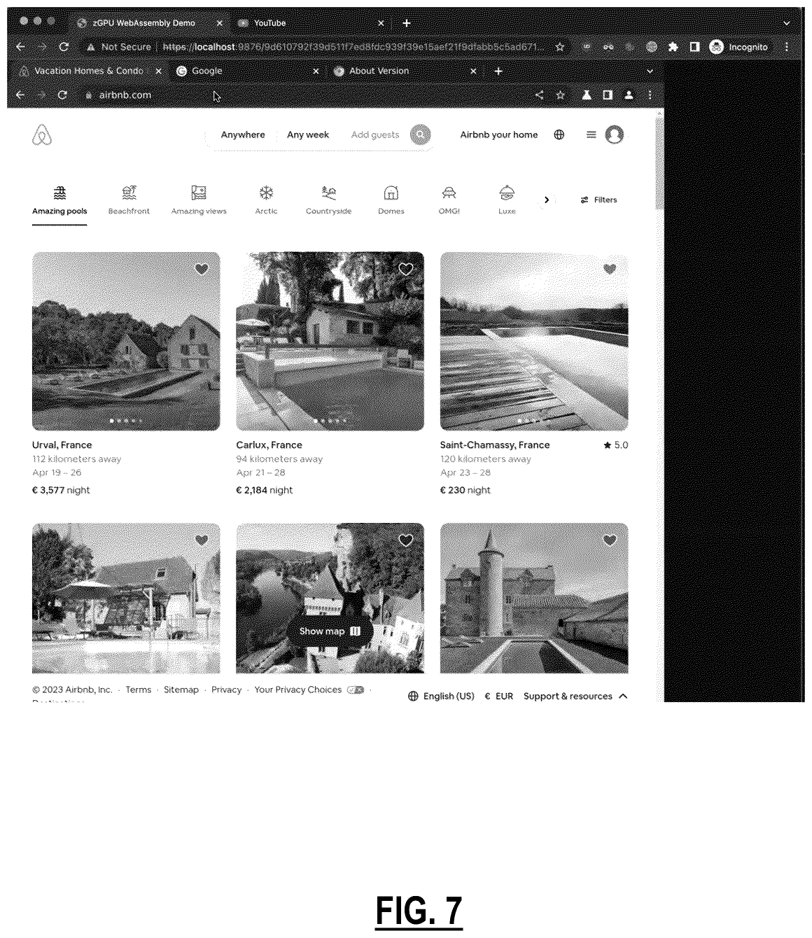

In various embodiments, GPU commands are encoded using a minimal binary protocol, and compressed using Zstandard (ZSTD). These encoded and compressed commands are then sent over the network 606 (internet or intranet) to the client 300 using Transmission Control Protocol (TCP) utilizing various Network Interface Controllers (NIC) 608 at the server 200 and client 300. For example, in an embodiment, the GPU commands are sent to a client 300 from the cloud-based system 100 over the network 606. At the user device, the commands are then sent to a decoder (zGPU decoder) 610 which maps resources and properly orders and synchronizes the commands. In an embodiment, the decoded commands are passed to an API (WebGL) for rendering the interactive graphics within the browser 612. These graphics are then sent through a rendering API of the devices operating system, and subsequently displayed on the devices screen. In an embodiment, the displayed graphics can be presented to a user within the browser 612 (native browser) as shown in FIG. 7.

In various embodiments, the present systems can be utilized to render a complete instance of an application, for example Chromium, inside of a browser. In the example shown in FIG. 7, an instance of Chromium is rendered inside of the Safari browser. The system can further be adapted to utilize GPU memory for caching previously rendered content, thereby minimizing the need to re-render content as the application instance, for example the Chromium instance, is being used.

In various embodiments, zGPU is adapted to run all code on servers of the cloud-based system, while the code only has access to the sandbox created for the client. GPU commands are sent to the client browser which are decoupled from the code, and is run in WebAssembly which has no access to networking API meaning it is safeguarded by cross origin access policy.

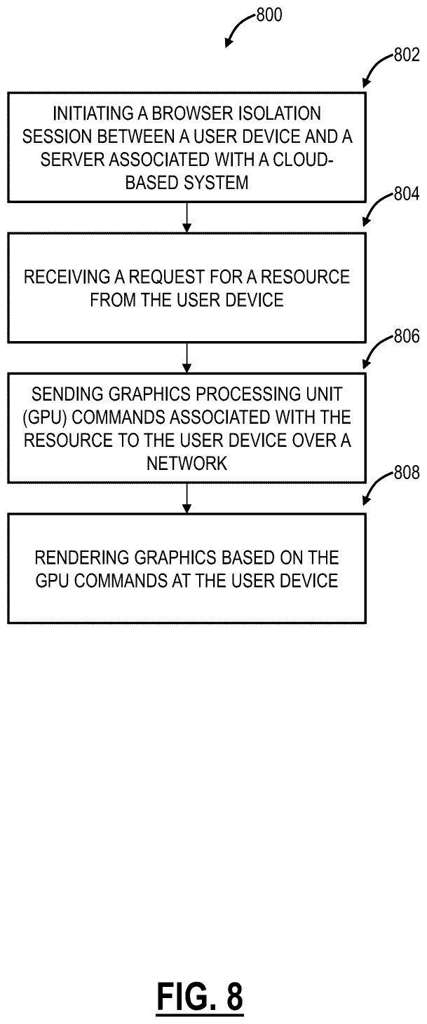

FIG. 8 is a process 800 for providing browser isolation via a virtualized Graphics Processing Unit (GPU). The process 800 includes initiating a browser isolation session between a user device and a server associated with a cloud-based system (step 802); receiving a request for a resource from the user device (step 804); sending Graphics Processing Unit (GPU) commands associated with the resource to the user device over a network (step 806); and rendering graphics based on the GPU commands at the user device (step 808).

The steps can further include displaying the graphics within a browser operating on the user device. The steps can further include encoding the GPU commands at the server prior to the sending and decoding the GPU commands at the user device prior to the rendering. All code associated with the resource is executed at the server prior to the sending. Code associated with the resource can be executed in a sandbox at the server. The GPU commands can be sent over the network to a browser executing on the user device, wherein the GPU commands are decoupled from code associated with the resource. The resource can be any of a remote application, a browser, and an entire desktop environment. The steps can further include simulating a GPU device in the server for executing code thereon. No rendering is performed on the server. The commands can be sent over the network to the user device utilizing Transmission Control Protocol (TCP).

### GPU Forking

As described herein the present cloud-based isolation leverages technology known as “GPU Virtualization.” This technology enables a remote application to render graphics with high efficiency on a client/user device 300 by transmitting rendering instructions directly to that client. Essentially, it allows the heavy lifting of graphical computation to be handled by a powerful GPU, with the rendered output then being sent to the user's device. Existing solutions in the market have consistently struggled to deliver a truly seamless and fluid user experience. This is especially pronounced in scenarios where there is significant latency between the server 200 and the client/user device 300, which typically becomes problematic when the latency exceeds 5 milliseconds.

The challenge with current GPU virtualization solutions is that they often fail under high-latency conditions, leading to noticeable lag and interruptions that can severely diminish the user experience. This is a critical issue in today's digital landscape, where users expect instantaneous and smooth interactions, whether they are navigating a web application, streaming content, or engaging in complex graphical tasks.

To overcome these inherent challenges and ensure an optimal user experience, the present disclosure provides systems and methods for “GPU forking”. This advanced technology addresses a critical performance issue that occurs when an application relies on a remote GPU for rendering. GPU forking works by intelligently distributing the rendering tasks across one or more virtualized GPU 602 instances, effectively parallelizing the workload and minimizing the latency impact. This means that even when there is a high latency between the server and the client, the rendering process remains smooth and efficient. In various embodiments, a single virtual GPU is initiated and utilized on the same server as the application being rendered. By doing this, only rendering instructions are sent to the client device. For example, instead of sending all the pixels in a 100×100 rectangle (which takes 4 bytes per pixels=4 MB), the system sends a single “draw a 100×100 rectangle” instruction, which only takes a few bytes.

Through GPU forking, the present system can significantly enhance the rendering process, ensuring smooth and efficient performance even in high-latency environments. This innovative solution sets the cloud-based isolation apart, providing users with an unparalleled level of responsiveness and visual fidelity. By ensuring that the remote application can render graphics quickly and accurately, regardless of the distance between the server 200 and the client/user device 300, the present systems are able to deliver a user experience that feels local, immediate, and immersive.

When examining the most widely-used technology for rendering to remote GPUs, X11 GLX, it becomes evident that it suffers from significant latency and frame-rate issues when the server and client are not housed on the same machine. This inefficiency arises primarily because each time the application needs to perform a “read” operation, it must execute a network round-trip to the client 300. Consequently, if the ping time between the client 300 and server 200 is 50 milliseconds, each read operation will inherently take at least 50 milliseconds to complete. This latency becomes particularly problematic for GPU applications, which typically require multiple read operations per frame. To achieve a smooth rendering performance at 60 frames per second (FPS), each frame must be rendered in less than 16 milliseconds. Therefore, the high latency induced by network round-trips severely hampers the ability to maintain the desired frame rate, leading to a subpar user experience characterized by stuttering and delays.

The new isolation approach described herein fundamentally reimagines the way remote GPU rendering is handled. Instead of relying on traditional methods that necessitate frequent and latency-inducing network round-trips for read operations, the concept of a “virtual GPU” that operates directly on the server 200 is introduced. This method ensures that all read operations are performed locally on the server 200, effectively eliminating the need for the client to participate in these operations. As a result, clients 300 are transformed into “push only” entities as they solely receive rendering instructions from the server without the necessity of sending any data back.

To make this architecture work seamlessly, it is crucial to maintain synchronization between the local “virtual GPU” 602 on the server 200 and the remote physical GPU 902. Both GPUs need to be in the same state to ensure accurate and consistent rendering. This synchronization is achieved through the use of advanced techniques such as compute fences and memory barriers. Compute fences help coordinate the execution order of the GPU tasks, ensuring that the rendering instructions are processed in the correct sequence. Memory barriers ensure that any changes in data are accurately reflected and shared between the local and remote GPUs.

By implementing this synchronization process, the system can maintain a high degree of coherence between the virtual and physical GPUs, allowing for a smooth and efficient rendering experience. This approach not only significantly reduces latency but also enhances the overall performance and responsiveness of GPU applications. Users can enjoy a more fluid and immersive experience, free from the disruptions and delays that typically plague traditional remote rendering solutions.

GPU forking is a sophisticated technology that enhances the performance and efficiency of rendering operations within the cloud-based system 100. It works by leveraging the power of GPU virtualization to distribute rendering tasks across one or more virtualized GPU 602 instances, ensuring smooth and responsive user experiences even in scenarios with high latency. Within the cloud-based system 100, GPU forking begins by creating one or more virtual GPU 602 instances, which act as virtualized versions of physical GPUs capable of handling rendering tasks just like their hardware counterparts. When a rendering request is received, GPU forking intelligently distributes the workload across these virtual GPU 602 instances. This parallel processing approach ensures that the rendering tasks are handled efficiently, reducing the time required to complete each frame.

Unlike traditional remote GPU rendering solutions that rely heavily on network round-trips for read operations, GPU forking performs all read operations locally within the cloud-based system 100. This eliminates the latency issues associated with network delays, as the virtual GPUs 602 on the server 200 handle these operations internally. In this architecture, clients 300 are designed to be “push only.” They receive rendering instructions from the cloud-based system 100 without needing to send any data back, which significantly reduces the load on the client side and minimizes the chances of latency-related performance issues.

To ensure that the virtual GPU 602 instances and the remote physical GPUs 902 (if involved) are in sync, GPU forking employs advanced synchronization mechanisms. Compute fences and memory barriers are used to coordinate the execution order of tasks and ensure that data changes are accurately reflected. This synchronization process maintains a consistent state across all GPUs involved in the rendering process. By handling all read operations locally and distributing rendering tasks across one or more virtual GPUs, GPU forking reduces the overall latency of the rendering process. This optimization is crucial for providing a smooth and responsive user experience, even when there is significant network latency between the client and the cloud-based system.

GPU forking is designed to be highly scalable, allowing the cloud-based system 100 to handle a large number of concurrent rendering requests efficiently. The ability to distribute tasks across one or more virtual GPUs 602 ensures that the system can maintain high performance levels, even under heavy load. In summary, GPU forking within the cloud-based system 100 leverages virtual GPU 602 instances to handle rendering tasks efficiently, eliminates the need for network round-trips for read operations, and employs advanced synchronization techniques to maintain a consistent state across all GPUs.

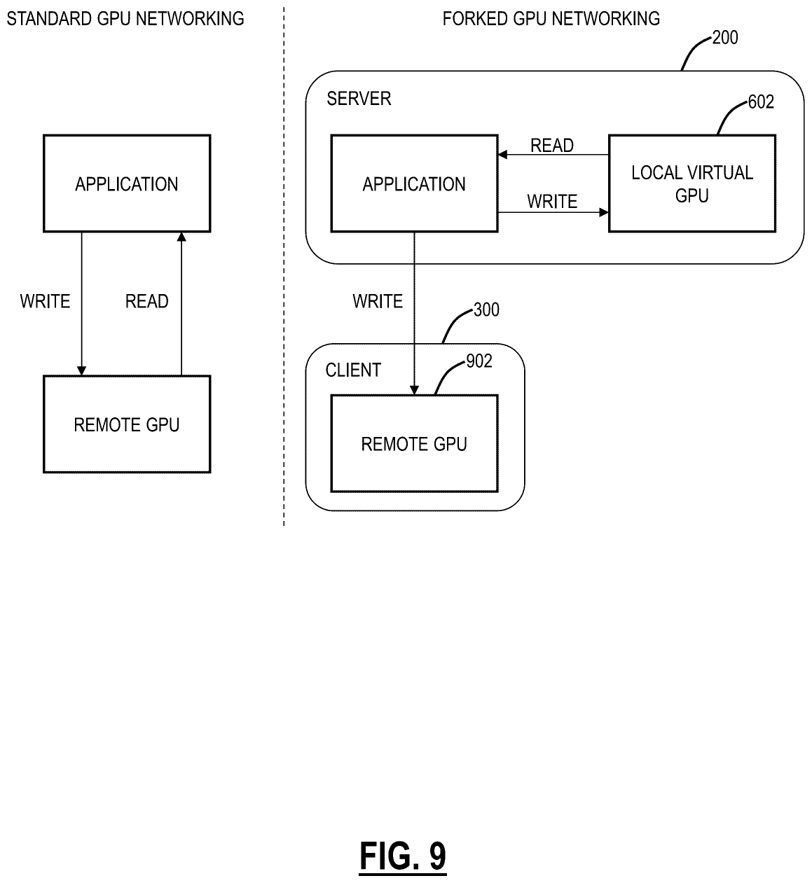

FIG. 9 is a flow diagram representing GPU forking in contrast to standard GPU networking. As described, the cloud-based system 100 performs several specific steps to implement GPU forking, ensuring efficient and high-performance rendering operations. In various embodiments, the process begins with the initialization of virtual GPU 602 instances, where the cloud-based system 100 creates multiple virtual GPUs 602 on its servers that are designed to handle rendering tasks. further, in various embodiments, these virtual GPUs 602 are initialized on the same server as the application being requested by a client 300. Necessary computational resources, such as memory and processing power, are allocated to each virtual GPU 602 instance to ensure optimal performance.

When a rendering request is received from a client 300, the cloud-based system 100 processes this request, which includes details about the rendering tasks that need to be performed. The cloud-based system 100 then analyzes the rendering tasks to determine the most efficient way to distribute the workload across the available virtual GPU 602 instances. Rendering tasks are intelligently distributed across multiple virtual GPU 602 instances through parallel processing, ensuring tasks are handled concurrently and reducing the overall time required to render each frame. Additionally, load balancing dynamically distributes the load among the virtual GPU 602 instances to prevent any single instance from becoming a bottleneck.

All read operations are performed locally within the cloud-based system 100, eliminating latency issues associated with network delays. The virtual GPU 602 instances execute the rendering tasks, processing the instructions and generating the rendered output. Synchronization mechanisms, such as compute fences and memory barriers, are used to coordinate the execution order of tasks across the virtual GPU 602 instances and ensure that any changes in data are accurately reflected and shared between the local virtual GPUs 602 and any remote physical GPUs 902 involved, maintaining a consistent state across all GPUs.

The push-only client model means that rendered output and instructions are pushed to the user devices 300, which receive these instructions without needing to send any data back. This significantly reduces the load on the client side and minimizes latency-related performance issues.

### GPU Forking Process

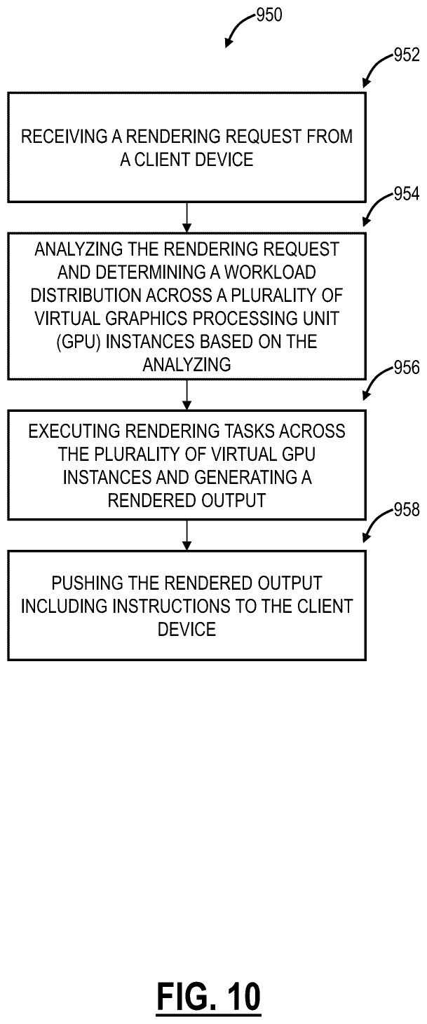

FIG. 10 is a flowchart of a process 950 for providing browser isolation via virtualized Graphics Processing Units (GPUs). The process 950 can be contemplated as a method with steps, a cloud-based system configured to implement the steps, and a non-transitory computer-readable medium storing computer-executable instructions for causing performance of the steps. The process 950 includes receiving a rendering request from a client device (step 952); analyzing the rendering request and determining a workload distribution across a plurality of virtual Graphics Processing Unit (GPU) instances based on the analyzing (step 954); executing rendering tasks across the plurality of virtual GPU instances and generating a rendered output (step 956); and pushing the rendered output including instructions to the client device (step 958).

The process 950 can further include, prior to the receiving, initiating a browser isolation session between the client device and a server associated with the cloud-based system. The steps can further include, prior to the receiving, initializing a plurality of virtual GPU instances within one or more servers of the cloud-based system. The steps can further include allocating computational resources including memory and processing resources to each of the plurality of virtual GPU instances. The steps can further include distributing the rendering tasks in parallel across the plurality of virtual GPU instances. The executing can include performing all read operations locally within the cloud-based system. The rendering request can be associated with any of a remote application, a browser, and an entire desktop environment. The steps can further include synchronizing states of the plurality of virtual GPU instances and a remote physical GPU of the client device. The synchronizing can be performed via any of compute fences and memory barriers. In various embodiments, no rendering is performed on the client device.

### Conclusion

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A method implemented by a cloud-based system, the method comprising steps of:
receiving a rendering request from a client device;
analyzing the rendering request and determining a workload distribution across a plurality of virtual Graphics Processing Unit (GPU) instances based on the analyzing;
executing rendering tasks across the plurality of virtual GPU instances and generating rendering instructions; and
pushing the rendering instructions to the client device.

2. The method of claim 1, wherein the steps comprise, prior to the receiving, initiating a browser isolation session between the client device and a server associated with the cloud-based system.

3. The method of claim 1, wherein the steps comprise, prior to the receiving, initializing a plurality of virtual GPU instances within one or more servers of the cloud-based system, wherein the one or more virtual GPU instances are located on a same server as an application associated with the request.

4. The method of claim 3, wherein the steps comprise allocating computational resources including memory and processing resources to each of the plurality of virtual GPU instances.

5. The method of claim 1, wherein the steps comprise distributing the rendering tasks in parallel across the plurality of virtual GPU instances.

6. The method of claim 1, wherein the executing includes performing all read operations locally within the cloud-based system.

7. The method of claim 1, wherein the rendering request is associated with any of a remote application, a browser, and an entire desktop environment.

8. The method of claim 1, wherein the steps comprise synchronizing states of the plurality of virtual GPU instances and a remote physical GPU of the client device.

9. The method of claim 8, wherein the synchronizing is performed via any of compute fences and memory barriers.

10. The method of claim 1, wherein only rendering instructions to render an output are provided to the client device.

11. A non-transitory computer-readable medium comprising instructions that, when executed, cause one or more processors associated with a cloud-based system to perform steps of:
receiving a rendering request from a client device;
analyzing the rendering request and determining a workload distribution across a plurality of virtual Graphics Processing Unit (GPU) instances based on the analyzing;
executing rendering tasks across the plurality of virtual GPU instances and generating rendering instructions; and
pushing the rendering instructions to the client device.

12. The non-transitory computer-readable medium of claim 11, wherein the steps comprise, prior to the receiving, initiating a browser isolation session between the client device and a server associated with the cloud-based system.

13. The non-transitory computer-readable medium of claim 11, wherein the steps comprise, prior to the receiving, initializing a plurality of virtual GPU instances within one or more servers of the cloud-based system.

14. The non-transitory computer-readable medium of claim 13, wherein the steps comprise allocating computational resources including memory and processing resources to each of the plurality of virtual GPU instances.

15. The non-transitory computer-readable medium of claim 11, wherein the steps comprise distributing the rendering tasks in parallel across the plurality of virtual GPU instances.

16. The non-transitory computer-readable medium of claim 11, wherein the executing includes performing all read operations locally within the cloud-based system.

17. The non-transitory computer-readable medium of claim 11, wherein the rendering request is associated with any of a remote application, a browser, and an entire desktop environment.

18. The non-transitory computer-readable medium of claim 11, wherein the steps comprise synchronizing states of the plurality of virtual GPU instances and a remote physical GPU of the client device.

19. The non-transitory computer-readable medium of claim 18, wherein the synchronizing is performed via any of compute fences and memory barriers.

20. The non-transitory computer-readable medium of claim 11, wherein only rendering instructions to render an output are provided to the client device.
